(19) United States
(12) Patent Application Publication
(10) Pub. No.: US 2013/0038448 A1
(43) Pub. Date: Feb. 14, 2013

(54) Access Control System

(71) Applicants: Kai Yew Paul Chong, Singapore (SG); Joon Keng Yong, Singapore (SG); Honching Lui, Singapore (SG); Liang Cheng Wang, Singapore (SG)

(72) Inventors: Kai Yew Paul Chong, Singapore (SG); Joon Keng Yong, Singapore (SG); Honching Lui, Singapore (SG); Liang Cheng Wang, Singapore (SG)

(73) Assignee: CERTIS CISCO SECURITY PTE LTD, Singapore (SG)

(21) Appl. No.: 13/481,467

(22) Filed: May 25, 2012

(30) Foreign Application Priority Data
Aug. 10, 2011 (SG) 201105732-0

(51) Int. Cl. G06F 7/04; G08B 13/00; G05B 19/00

(52) U.S. Cl. 340/541; 340/5.6; 340/5.52; 340/5.54

(57) ABSTRACT

An access control system is disclosed comprising a credential reader arranged to gather at least one credential from a person desiring to pass through an access point associated with the access control system, the system being arranged to use the at least one credential to provide an indication about the identity of the person. The system also comprises at least one access control device controlling access through a respective access point such that a person is allowed or denied access dependent on whether the person is positively identified, and a data storage device that stores data indicative of a current security level applicable for each access point associated with the system, the security level defining the criteria required to provide a positive identification of the person. Stored security level data can be modified to change the criteria required for positively identifying a person.

### CROSS-REFERENCE TO RELATED APPLICATION

This application claims the benefit under 35 U.S.C. §119 of Singaporean Patent Application No. 201105732-0, filed Aug. 10, 2011, which is hereby incorporated by reference in its entirety.

### BACKGROUND

1. Field of the Invention

The present invention relates to an access control system for controlling access to an area and/or resource by a person.

2. Background of the Invention

It is known to provide an access control system for electronically controlling access to areas and resources so that such access is restricted to authorised persons only. In one such system, access by persons through any one of a plurality of doors is controlled by providing each door with a credential reader for gathering one or more credentials from a person, such as a pin number or ID number stored on a card, and a backend system connected to the credential readers through a network. Verification of the gathered credentials may be carried out at or adjacent the credential readers or at the backend system.

However, this type of access control system is relatively inflexible since changes in system operation, in particular the security levels to be applied to each door, are difficult to make.

### BRIEF SUMMARY

An access control system comprising:

a credential reader arranged to gather at least one credential from a person desiring to pass through an access point associated with the access control system, the system being arranged to use the at least one credential to provide an indication as to the identity of the person;

at least one access control device arranged to control access through a respective access point such that access by a person is allowed or denied dependent on whether a positive decision as to the identity of the person is obtained; and

a data storage device arranged to store security level data indicative of a current security level applicable for the or each access point associated with the system, the security level defining the criteria required to provide a positive decision as to the identity of the person;

wherein the system is arranged to facilitate modification of the stored security level data so as to change the criteria required to be satisfied in order to provide a positive indication as to the identity of a person.

In one embodiment, the system is arranged to facilitate modification of the stored security level data by an operator. The security level data associated with each access point may be individually modifiable by an operator, and/or multiple access points may be grouped together and the security level data associated with a group of access points modified simultaneously by an operator.

In one embodiment, the system is arranged to facilitate modification of the stored security level data automatically based on defined modification rules. The rules may define the security level data according to the time of day, or day of the week.

In one embodiment, the modification rules used to automatically modify the security level data are modifiable by an operator.

In one embodiment, the security level defines the number of credentials required to be gathered from a person in order to provide a positive indication as to the identity of the person.

In one embodiment, the system comprises a wireless card reader for wirelessly reading an access card having an identifier indicative of a person stored on the card, and the credentials comprise the identifier

In one embodiment, the system comprises a biometric reader arranged to gather biometric information from a person, and the credentials comprise the biometric information.

In one embodiment, the system comprises a keypad arranged to enable a person to enter a PIN number, and the credentials comprise the PIN number.

In one embodiment, the system comprises a high security level wherein at least 3 credentials are required to be gathered from a person in order to provide a positive indication as to the identity of the person, a medium security level wherein 2 credentials are required to be gathered from a person in order to provide a positive indication as to the identity of the person, and a low security level wherein 1 credential is required to be gathered from a person in order to provide a positive indication as to the identity of the person.

In one embodiment, the security level defines the maximum false acceptance rate allowable for a person desiring to gain passage through an access point.

In one embodiment, the system is arranged to store reference credential data, to compare the reference credential data with corresponding gathered credential data, and to provide a positive or negative indication as to the identity of the person based on the comparison.

In one embodiment, the system comprises a network that may be an address based network, such as an IP based Ethernet network.

In one embodiment, the system comprises an access control station arranged to carry out the comparison between the reference credential data and the corresponding gathered credential data, the access control device being arranged to send gathered credential data to the access control station.

In one embodiment, the security level data is stored at the access control station. In an alternative embodiment, the credential reader is arranged to carry out the comparison between the reference credential data and the corresponding gathered credential data.

In one embodiment, the security level data associated with an access point is stored at the credential reader associated with the access point.

In an alternative embodiment, the access control device is arranged to carry out the comparison between the reference credential data and the corresponding gathered credential data. In one embodiment, the security level data associated with an access point is stored at the access control device associated with the access point.

In one embodiment, the system comprises a terminal usable by an operator to modify the stored security level data. The terminal may comprise a personal computer, a PDA, or a tablet computer.

In one embodiment, each access control device is arranged to control access through multiple access points.

In one embodiment, the access point is a door, turnstile, elevator, or gate.

The system may further comprise a lock for each access point, each lock being controlled by an access control device so as to allow or deny access through the access point.

In one embodiment, the system comprises a sensor arranged to detect whether the access point is open or closed, and the system comprises an alarm device arranged to produce an audible and/or visible alarm when the sensor detects that the access point is open in the absence of a positive indication as to the identity of a person.

### BRIEF DESCRIPTION OF THE DRAWINGS

The present invention will now be described, by way of example only, with reference to the accompanying drawings, in which:

FIG. 1 is a diagrammatic representation of an access control system in accordance with an embodiment of the present invention;

FIG. 2 is a block diagram of an access control device of the access control system shown in FIG. 1;

FIG. 3 is a block diagram of an access control station of the access control system shown in FIG. 1;

FIG. 4 is a block diagram illustrating functional components of the access control station shown in FIG. 3;

FIG. 5 illustrates an example security level control screen presented to a user of the access control system shown in FIG. 1 during use; and

FIG. 6 is a diagrammatic representation of an access control system in accordance with an alternative embodiment of the present invention.

### DETAILED DESCRIPTION

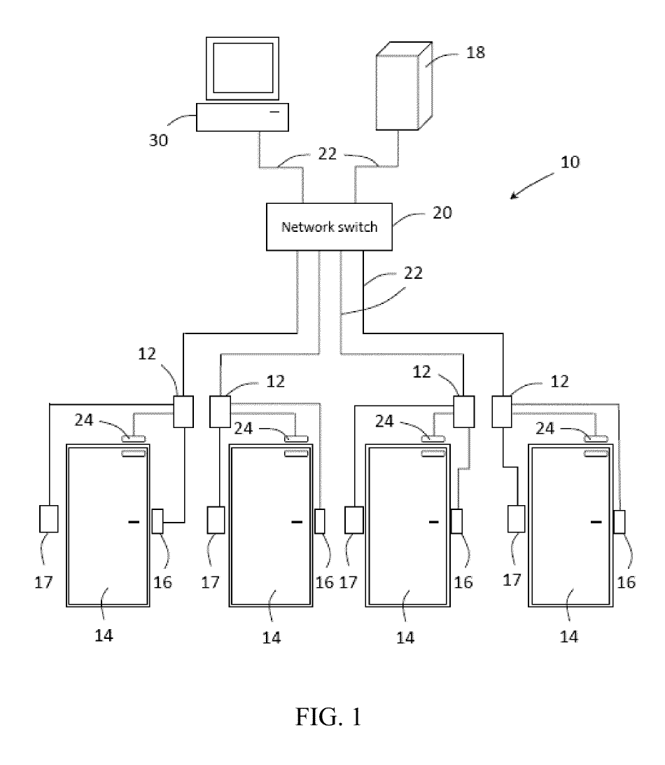

Referring to FIG. 1, an embodiment of an access control system 10 of the type wherein passage through an access point by a person is allowed or denied based on whether the identity of the person is positively verified is shown.

The system 10 includes a plurality of access control devices 12, each of which is associated with an access point 14, in this example in the form of a door. In this example, 4 access points 14 and 4 respective access control devices 12 are provided, although it will be understood that any number of access points 14 and associated access control devices 12 are envisaged. It is also envisaged that one or more of the access control devices 12 may be associated with multiple access points 14 or, as shown in FIG. 1, each access control device 12 may be associated with a single access point 14.

Each access point 14 also has an associated door lock 16 that in this example is controlled by a respective access control device 12 such that the door lock 16 may be caused to enable or inhibit opening of the access point 14 in response to an appropriate signal from the access control device 12.

Also associated with each access point 14 is a credential reader 17 for gathering one or more credentials from a person desiring to pass through the access point 14. In this example, each credential reader 17 is in the form of a card reader arranged to wirelessly read an identification number stored on a card in the possession of a person desiring to pass through the access point 14. However, it will be understood that any other device capable of gathering identification credentials from a person is envisaged, such as a biometric reader or a keypad for enabling a person to enter a PIN number.

While in this example the access points 14 are doors, it will be appreciated that other types of access point are envisaged, such as an elevator door, turnstile, parking gate, or any other physical barrier.

During operation, the credential reader 17 captures one or more credentials from a person desiring to pass through the access point 14 under control of a respective access control device 12, and the access control device 12 passes data indicative of the gathered credential(s) to an access control station 18 connected to the access control device 12 through a network. In this example, the network includes a network switch 20 for appropriately directing traffic through the network and a plurality of network connections 22 interconnecting the access control devices to the access control station 18 through the network switch 20.

In this example, the network is of a type wherein nodes of the network are addressable, such as an Ethernet-type network that uses IP protocols for data transfer. However, it would be understood that any suitable network architecture is envisaged.

On receipt of the credentials data at the access control station 18, the access control station 18 compares the credentials data with stored reference credentials data and makes a determination as to whether the credentials are valid. A response communication indicating whether a positive identification or a negative indication exists is sent from the access control station 18 to the relevant access control device 12. On receipt of the response communication, the access control device 12 then either maintains the door lock 16 in an activated state or deactivates the door lock 16 depending on whether the identification is positive or negative.

Each access point 14 has an associated security level that defines the degree of rigour to apply to the determination as to whether a person is deemed positively identified or negatively identified. A higher security level provides for a greater degree of rigour in identifying a person than a lower security level. In this way, a higher security level provides a greater likelihood that a person is correctly identified than a lower security level.

In this example, the security levels define criteria in the form of the number of factors of authentication required to be carried out in order to determine that a person is positively identified. The factors of authentication may include identification using an access card, using biometric data obtained directly from the person and/or using a PIN number. The security levels may also define other criteria relevant to making a determination as to the likelihood that a person is genuine, such as the maximum false acceptance rate.

In the present embodiment, 3 security levels are available, identified using the numerals 1, 2 and 3, with security level 1 corresponding to a relatively high security level, for example requiring 3 factors of authentication, and security level 3 corresponding to a relatively low security level, for example requiring 1 factor of authentication.

In this example, the security levels for each access point 14 are stored locally at the access control device 12 associated with the access point 14.

In this embodiment, each access point 14 has associated sensors 24, in this example to detect whether the access point is open or closed. Any suitable sensor for this purpose is envisaged, and in this example magnetic-type proximity sensors are used.

The sensors 24 are connected to a respective access control device 12 that monitors the sensors and sends a warning communication through the network to the access control station 18, for example to indicate to the access control station 18 when an access point 14 is open. The warning may be used to trigger an alarm, for example in the event that a sensor 24 indicates that an access point is open but that no valid credential verification has occurred.

The access control system 10 also includes an operator terminal 30 in communication with the network and arranged to enable an operator to modify the security levels used for the access points 14 in the access control system. The security levels used for the access points 14 may be fixed in that a specific security level is selected by an operator of the access control system 10, or may be automatic in that the security levels are defined according to a business rule such as time of day, day of the week, and so on.

For example, the security level for an access point may be changed on a temporary basis to a lower level for operational efficiency reasons to enable a larger number of people to pass through the access point in a given time. In a further example, the security level for an access point may be changed to a higher level because of a perceived increased threat of an unauthorised access attempt.

At the option of an operator of the access control system, different security levels may be individually set for different access points 14, for example depending on the type and/or location of the access point, and/or the security level may be changed for multiple access points simultaneously by grouping access points together. Alternatively, the security levels for all access points may be changed simultaneously.

The operator terminal 30 in this example is shown as a personal computer, although it will be understood that any device capable of communicating with a computer network and enabling an operator to view and modify settings for the security levels is envisaged. For example, the terminal may take the form of a laptop computer, a personal digital assistant (PDA), a mobile telephone, or a tablet computer.

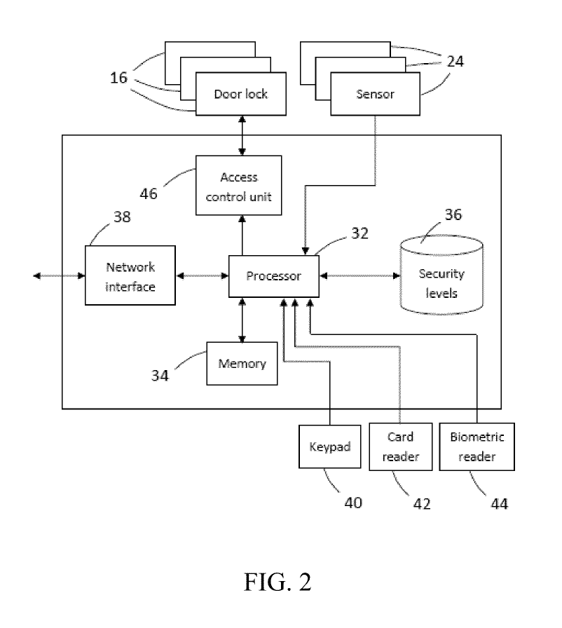

An example access control device 12 is shown in FIG. 2. The access control device 12 is shown connected to at least one door lock 16, and one or more credential readers 17 shown in this example as a keypad 14, a card reader 42 and a biometric reader 44.

In this embodiment, the access control device 12 is also connected to at least one sensor 24 for sensing whether an access point 14 is open or closed, although it will be understood that in some embodiments the sensors may be omitted.

The access control device 12 includes a processor 32 for controlling and co-ordinating operations in the access control device 12, a memory 35 usable by the processor 32 to store data indicative of programs used by the processor 32, and a data storage device, in this example in the form of a database 36, for storing security level data indicative of the security levels assigned to the access points(s) 14 associated with the access control device 12.

The access control device 12 also includes a network interface 38 that provides the access control device with network communication capability, and an access control unit 46 arranged to control the or each door lock 16 associated with the access control device 12, and in particular to control activation or de-activation of the or each door lock 16 so that passage through the access point 14 is allowed or denied. The access control unit 46 is responsive to instructions generated by the processor 32 based on a communication received through the network interface 38 from the access control station 18 indicative of whether a person's credentials are verified or not.

During use, the access control device 12 uses the security levels stored in the data storage device to govern the degree of rigour to apply to identification of a person, in particular the number of credentials to gather from the person. After gathering the required credential(s), data indicative of the credential(s) are forwarded to the access control station for verification.

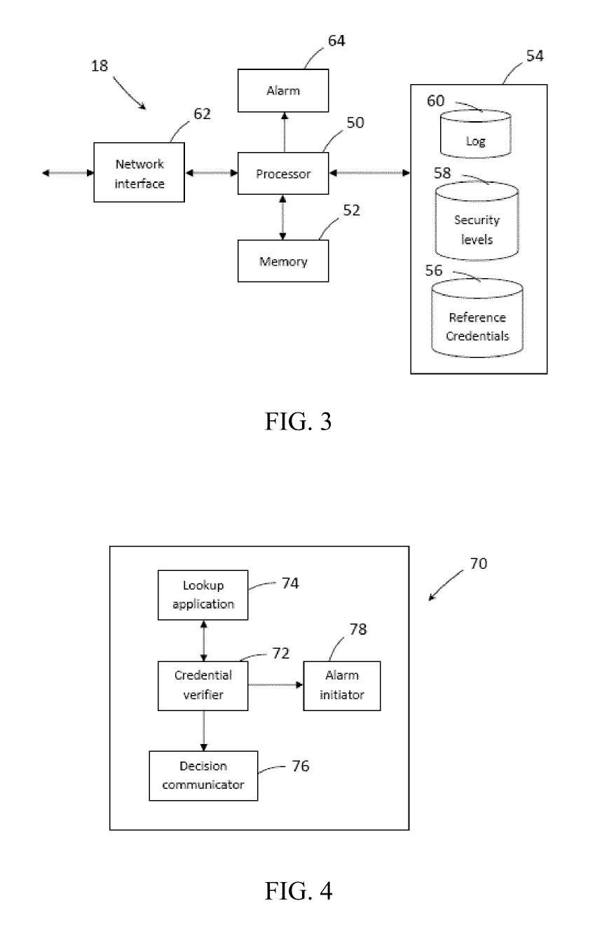

An example architecture of the access control station 18 is shown in more detail in FIG. 3.

The access control station 18 includes a processor 50 for controlling and co-ordinating operations in the access control station 18, and a memory 52 for use by the processor 50, in particular for storing programs used by the processor 50 to implement required functionality.

The access control station 18 also includes a data storage device 54, in this example in the form of a computer hard drive usable to store data indicative of credentials of people authorised to pass through one or more access points 14. The stored credentials 56 are used as reference credentials for comparison with credentials gathered directly from people desiring to pass through the access points 14. In this example, the data storage device 54 also stores data indicative of the security levels 58 for all access points 14 associated with the access control system 10, for example for back-up purposes, and log data 16 indicative of all successful and unsuccessful access attempts.

The access control station 18 also includes a network interface 62 that enables the access control station 18 to communicate with the network, and an alarm device 64 arranged to generate an audible and/or visible alarm in response to an alarm signal received from the processor 50, for example in response to a signal from an access control device 12 indicative that an access point 14 has been subjected to an unauthorised breach.

In this example, the access control station 18 is implemented using a PC server, although it will be understood that any suitable computing device is envisaged

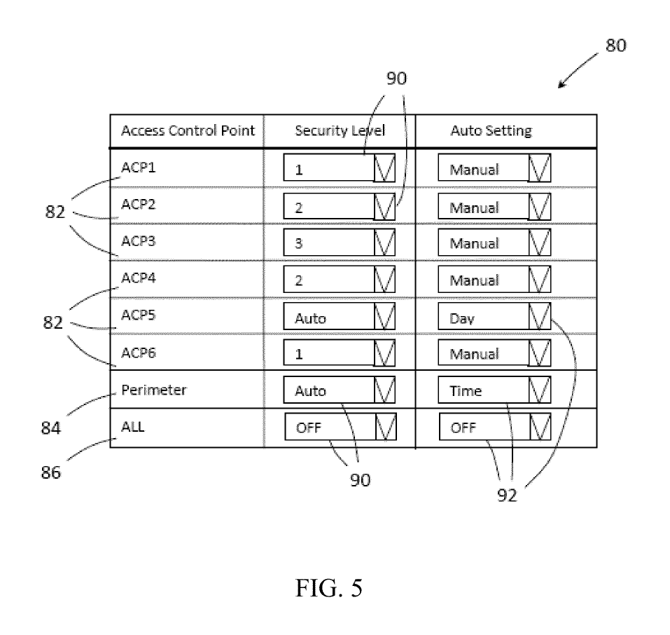

A functional diagram indicating functional components implemented by the processor 50 and associated memory 52 of the access control station 18 is shown in FIG. 4. The functional components include a credential verifier 72 arranged to receive data indicative of a credential gathered from a person desiring to pass through an access point 14, and to compare the gathered credential data with corresponding reference credential data stored in the data storage device 54. For this purpose, the credential verifier 72 uses a look up application 74 that extracts the relevant reference credential(s) for comparison with the gathered credential(s) by the credential verifier 72. A decision communicator 76 then generates a decision communication indicative of whether the gathered credential and the reference credential match and the decision communication is sent through the network interface 62 to the relevant access control device 12.

The functional components also include an alarm initiator 78 arranged to make a determination as to whether an alarm condition exists and to interface with the alarm device 64 to generate an alarm when required.

It will be understood that each access control device 12 has associated stored security levels that define the security level to be used for each of the access points 14 that are connected to the access control device 12. In this example, the security levels for the access points 14 connected to an access control device 12 are stored in the access control device 12, although it will be understood that other arrangements are possible. For example, the relevant security levels for an access control device 12 may be stored centrally at the access control station 18 and accessed directly by the access control device 12 when required.

It will also be understood that the security levels may in addition or alternatively be stored at the credential readers 17, and each of the credential readers 17 may include a processor and associated memory for implementing required functions for applying the security levels, and a data storage device for storing the security levels.

Using the operator terminal 30, an operator is able to modify the stored security levels used by the access control devices 12, in this example by accessing a security level control screen 80, an example of which is shown in FIG. 5.

The security level control screen 80 includes access point labels 82 indicative of the access control points 14 associated with the system 10, and also access point group labels 84, 86 that group together multiple access points 14 according to type or location, or that group all available access points together.

The security level control screen 80 also includes a security level drop box 90 usable by an operator to select the desired security level for each access point 14, or for multiple access points that have been grouped together. In this example, the available security levels are 1, 2 or 3 corresponding to high, medium and low security levels, an automatic setting, or an off setting. A high security level requires 3 factors of authentication, such as PIN number, card verification, and biometric verification; a medium security level requires 2 factors of authentication, such as PIN number and card verification; and a low security level requires 1 factor of authentication, such card verification.

The operator may choose to individually define the security level for each access point 14, or may choose to define an automatic setting wherein the security level for each access point is dependent on one or more rules.

The type of automatic setting may be further defined using automatic setting drop boxes 92, for example so as to cause the security level to be defined according to the time of day, according to the day of the week, and so on.

The security level settings entered by an operator using the security level control screen 80 are communicated through the network to the relevant access control devices 12, and/or in some embodiments wherein the credential readers 17 in addition or alternatively store the security levels, to the credential readers 17. The communicated security level settings are stored in the relevant data storage devices 36 for subsequent use to govern the security levels to be applied to the access points 14.

It will be understood that by using the security level control screen 80 an operator is able to quickly and easily modify the security level settings for any of the access points 14 associated with the system whilst the access control system 10 is operational. Separate off-line modification and updating of security level settings in the access control devices 12 and/or the credential reader 17 is not necessary.

It will also be understood that the particular user interface shown in FIG. 5 for enabling an operator to modify the security level settings used by the access control devices 12 is exemplary only and other user interfaces are envisaged. The important aspects is that an operator is able to use the terminal 30 to select and modify security levels to be used by the access control devices 12, and the selected security levels are subsequently stored and accessed by the access control devices 12 in order to set the security level to be applied to the access points 14.

Furthermore, it will be understood that the system may be arranged such that the security levels are modifiable only by authorised operators, and for this purpose the system may require the operator to execute a log in procedure prior to allowing the operator to change the security levels.

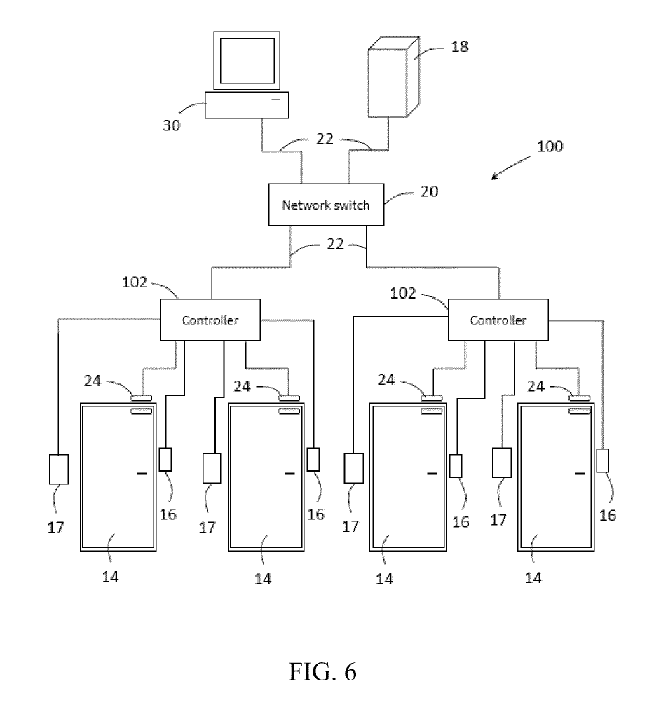

The above embodiment is described in relation to an access control system of the type wherein each of the access control devices 12 is network enabled and the access control devices 12 communicate with the access control station 18 and the terminal 30 through an IP address based network. However, it will be understood that other configurations are possible. For example, as shown in FIG. 6, an alternative access control system 100 is shown.

Like and similar features are indicated with like reference numerals. With this embodiment, an IP address based network facilitates communications between the access control station 18, the terminal 30 and one or more access controllers 102. Each access controller 102 interfaces with the IP address based network and performs the functions of multiple access control devices 12.

It will also be appreciated that instead of providing an access control station 18 in networked communication with the access control devices and arranged to make decisions as to whether gathered credentials are valid, any other architecture suitable for providing the access control devices with an indication as to whether gathered credentials are valid is envisaged. For example, the reference criteria may be stored locally relative to the access control devices, and the access control devices provided with the capability of making decisions as to whether gathered credentials are valid based on comparisons between gathered credentials and the locally stored credentials.

In one particular such embodiment, the reference credentials are stored at the credential reader 17 or at the access control devices 12, and for this purpose the credential reader and/or the access control devices 12 may include functional components similar to the functional components provided at the access control station 18 of the embodiment shown in FIGS. 1 to 5, that is, a credential verifier 72, a lookup application 74, and a decision communicator 76.

It will also be appreciated that in some embodiments, at least some reference credentials may be stored on a user access card, the reference credentials being extracted from the access card by a card reader, and compared to credentials such as a PIN number or biometric information gathered directly from a user when the user desires to pass through an access point.

Modification and variations as would be apparent to a skilled addressee are deemed to be within the scope of the present invention.

What is claimed is:

1. An access control system comprising:
a credential reader arranged to gather at least one credential from a person desiring to pass through an access point associated with the access control system, the system being arranged to use the at least one credential to provide an indication as to the identity of the person;
at least one access control device arranged to control access through a respective access point such that access by a person is allowed or denied dependent on whether a positive decision as to the identity of the person is obtained; and
a data storage device arranged to store security level data indicative of a current security level applicable for the or each access point associated with the system, the security level defining the criteria required to provide a positive decision as to the identity of the person,
wherein the system is arranged to facilitate modification of the stored security level data so as to change the criteria required to be satisfied in order to provide a positive indication as to the identity of a person.

2. An access control system as claimed in claim 1, wherein the system is arranged to facilitate modification of the stored security level data by an operator.

3. An access control system as claimed in claim 2, wherein the system is arranged such that only an authorised operator is able to modify the stored security level data.

4. An access control system as claimed in claim 1, wherein the security level data associated with each access point is individually modifiable by an operator.

5. An access control system as claimed in claim 1, wherein the system is arranged so that multiple access points are groupable together and the security level data associated with a group of access points are modifiable simultaneously by an operator.

6. An access control system as claimed in claim 1, wherein the system is arranged to facilitate modification of the stored security level data automatically based on defined modification rules.

7. An access control system as claimed in claim 6, wherein the modification rules define the security level data according to the time of day, or day of the week.

8. An access control system as claimed in claim 6, wherein the modification rules are modifiable by an operator.

9. An access control system as claimed in claim 1, wherein the security level defines the number of credentials required to be gathered from a person in order to provide a positive indication as to the identity of the person.

10. An access control system as claimed in claim 1, wherein the system comprises a wireless card reader for wirelessly reading an access card having an identifier indicative of a person stored on the card, and the credentials comprise the identifier.

11. An access control system as claimed in claim 1, wherein the system comprises a biometric reader arranged to gather biometric information from a person, and the credentials comprise the biometric information.

12. An access control system as claimed in claim 1, wherein the system comprises a keypad arranged to enable a person to enter a PIN number, and the credentials comprise the PIN number.

13. An access control system as claimed in claim 1, wherein the system comprises a high security level wherein at least 3 credentials are required to be gathered from a person in order to provide a positive indication as to the identity of the person, a medium security level wherein 2 credentials are required to be gathered from a person in order to provide a positive indication as to the identity of the person, and a low security level wherein 1 credential is required to be gathered from a person in order to provide a positive indication as to the identity of the person.

14. An access control system as claimed in claim 1, wherein the security level defines the maximum false acceptance rate allowable for a person desiring to gain passage through an access point.

15. An access control system as claimed in claim 1, wherein the system is arranged to store reference credential data, to compare the reference credential data with corresponding gathered credential data, and to provide a positive or negative indication as to the identity of the person based on the comparison.

16. An access control system as claimed in claim 1, wherein the system comprises a network that may be an address based network, such as an IP based Ethernet network.

17. An access control system as claimed in claim 16, wherein the system comprises an access control station arranged to carry out the comparison between the reference credential data and the corresponding gathered credential data, the access control device being arranged to send gathered credential data to the access control station through the network.

18. An access control system as claimed in claim 17, wherein the security level data is stored at the access control station.

19. An access control system as claimed in claim 15, wherein the access control device is arranged to carry out the comparison between the reference credential data and the corresponding gathered credential data.

20. An access control system as claimed in claim 18, wherein the reference credential data is stored at the access control station.

21. An access control system as claimed in claim 18, wherein the security level data associated with an access point is stored at the access control device associated with the access point.

22. An access control system as claimed in claim 15, wherein the credential reader is arranged to carry out the comparison between the reference credential data and the corresponding gathered credential data.

23. An access control system as claimed in claim 22, wherein the reference credential data is stored at each credential reader.

24. An access control system as claimed in claim 22, wherein the security level data associated with an access point is stored at the credential reader associated with the access point.

25. An access control system as claimed in claim 1, comprising a terminal usable by an operator to modify the stored security level data.

26. An access control system as claimed in claim 25, wherein the terminal comprises a personal computer, a PDA, or a tablet computer.

27. An access control system as claimed in claim 1, wherein each access control device is arranged to control access through multiple access points.

28. An access control system as claimed in claim 1, comprising a sensor arranged to detect whether the access point is open or closed, and an alarm device arranged to produce an audible and/or visible alarm when the sensor detects that the access point is open in the absence of a positive indication as to the identity of a person.
